(19) United States
(12) Patent Application Publication
(10) Pub. No.: US 2013/0307234 A1
(43) Pub. Date: Nov. 21, 2013

(54) MOBILITY SCOOTER TRAILER

(71) Applicant: Judy Ann Anders, Denison, TX (US)

(72) Inventor: Judy Ann Anders, Denison, TX (US)

(21) Appl. No.: 13/471,952

(22) Filed: May 15, 2012

(51) Int. Cl. B62D 63/08; B60D 1/06; B62D 61/06; B62D 61/00

(52) U.S. Cl. 280/32.7; 280/63; 280/511; 280/62

(57) ABSTRACT

A trailer a method for transporting a person adapted to be attached to a mobility scooter. The trailer includes a platform base supported on at least two wheels, at least one seat on the platform base, and a hitching assembly to attach the platform base to the motorized scooter.

### TECHNICAL FIELD OF THE INVENTION

The present invention relates generally to a trailer for transporting a person adapted to be attached to a mobility scooter. More specifically, the present invention relates to a trailer including a platform base supported on at least two wheels, at least one seat on the platform base, and a hitching assembly to attach the platform base to the motorized scooter.

### BACKGROUND OF THE INVENTION

Various companies manufacture personal mobility vehicles such as electric scooters powered by a storage battery. Such scooters are typically used by handicapped or disabled persons to improve their mobility. The mobility scooter is a mobility aid equivalent to a wheelchair but configured like a motorscooter. A mobility scooter has a seat over several wheels, a flat area or foot plates for the feet, and handlebars in front to turn one, two or three steerable wheels. The seat may swivel to allow access when the front is blocked by the handlebars. Mobility scooters are usually battery powered. Assistive and small sit-down motor scooters provide important advantages to people with mobility problems throughout the world. A scooter is useful for persons without the stamina or arm/shoulder flexibility necessary to use a manual wheelchair. Also, swiveling the seat of an electric scooter is generally easier than moving the foot supports on most conventional wheelchairs. A mobility scooter is very helpful for persons with systemic or whole-body disabling conditions (coronary or lung issues, some forms of arthritis, obesity, etc.) who are still able to stand and walk a few steps, sit upright without torso support, and control the steering tiller

A major selling point of mobility scooters for many users is that they do not look like a wheelchair, disability still being seen by many as a negative or somehow shameful. Mobility scooters are in general more affordable than powered wheelchairs, leading to them being procured as a cheaper alternative. It may be very difficult, however, for a person accompanying the rider of the scooter to keep up with the rider or travel distances that the rider is able to travel. The current invention relates to the issue of a second person (passenger), who might even be somewhat infirmed, requiring easy access to a more comfortable method of riding.

### SUMMARY OF THE INVENTION

According to an embodiment of the present invention, a trailer for transporting a person adapted to be attached to a mobility scooter. The trailer includes a platform base supported on at least two wheels, at least one seat on the platform base, and a hitching assembly to attach the platform base to the motorized scooter.

According to another embodiment of the present invention, a method of transporting a person on a trailer adapted to be attached to a mobility scooter. The method includes supporting a platform base on at least two wheels, securing at least one seat on the platform base, and attaching the platform base to the mobility scooter with a hitching assembly.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front three dimensional view of the mobility scooter trailer in accordance with the present invention.

FIG. 2 is a side view of the mobility scooter trailer attached, by means of a hitching assembly, to the rear of a motorized scooter, in accordance with the present invention.

FIG. 3 is a bottom view of the underside portion of the mobility scooter trailer, in accordance with the present invention.

FIG. 4 is a rear view of the mobility scooter trailer, in accordance with the present invention.

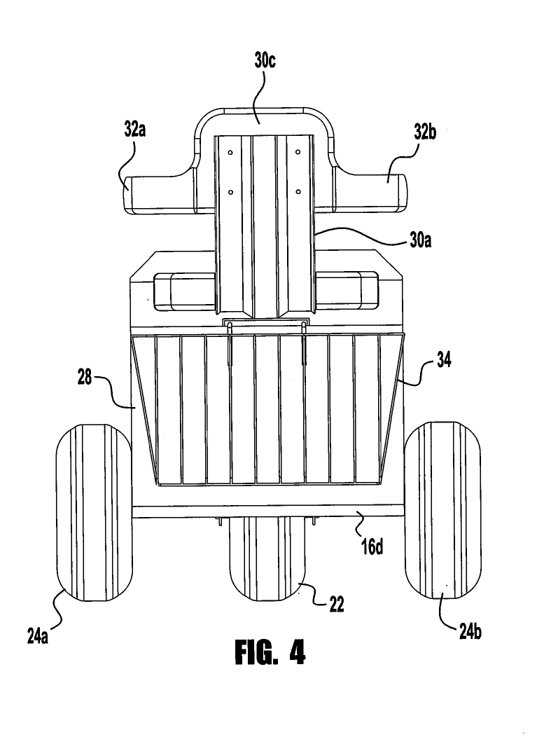

FIG. 5 is a detailed close view of the hitching ball of the mobility scooter trailer, in accordance with the present invention.

FIG. 6 is a detailed close view of the hitching assembly of the mobility scooter trailer, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

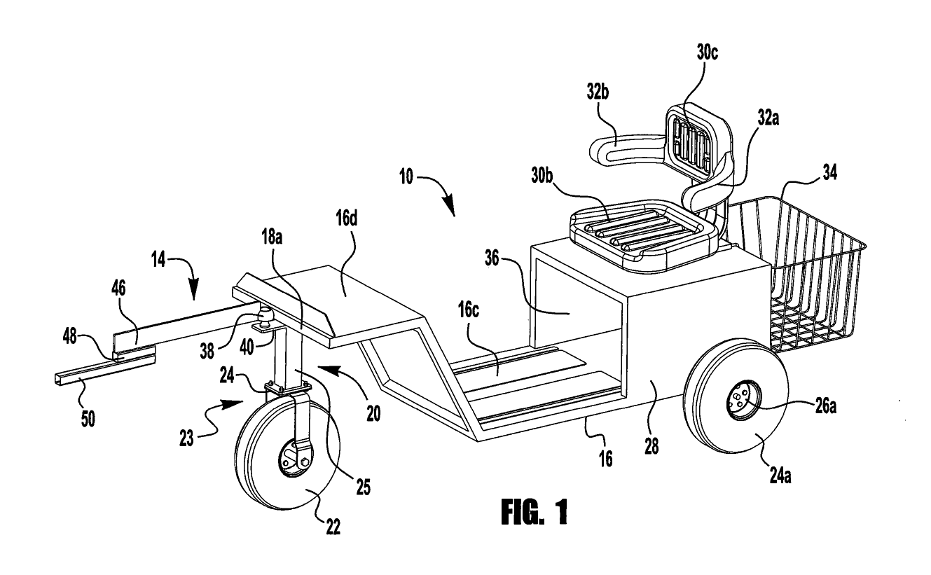

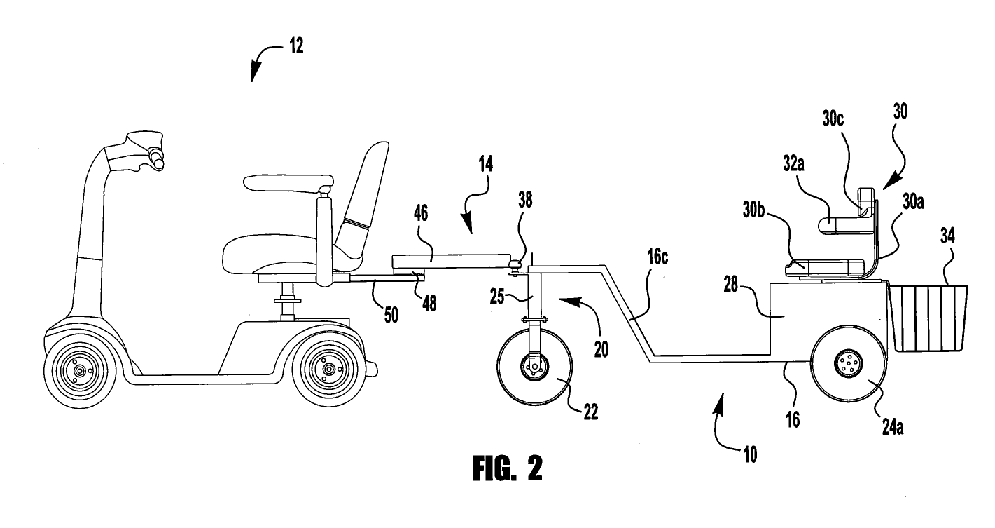

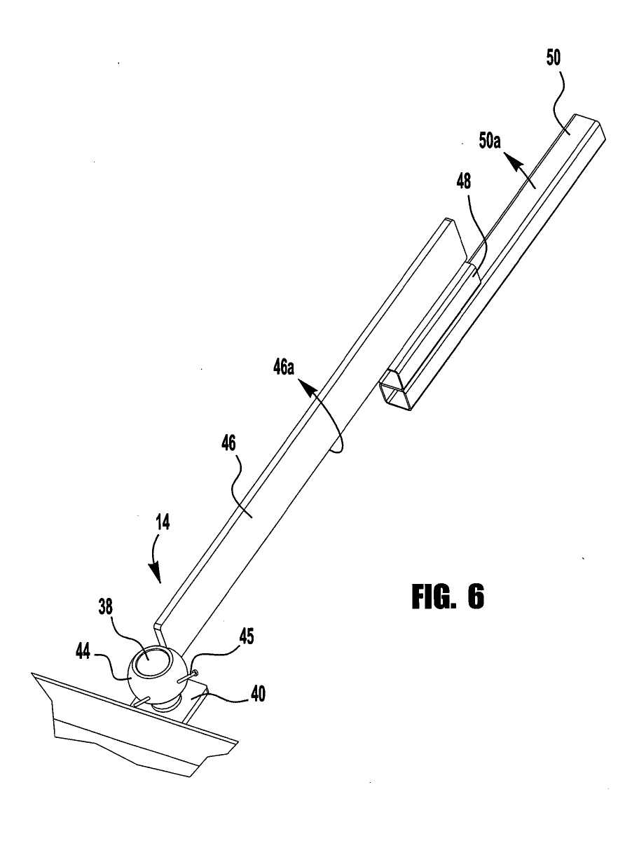

FIG. 1 illustrates a side, three-dimensional view of the mobility scooter trailer 10 (hereafter “trailer”), designed to attached to a motorized scooter 12, as seen in FIG. 2. Trailer 10 is constructed for the use of an accompanying rider with the motorized scooter 12 by providing both a comfortable seating arrangement as well as some additional storage space below the passenger's seat. Trailer 10 is connected to the rear of the motorized scooter 12 by means of a hitching assembly 14. A detailed view of the hitching assembly 14 is further illustrated in FIG. 6. It is within the terms of the invention that this connection between the trailer 10 and the motorized scooter 12 is removable or permanently attached.

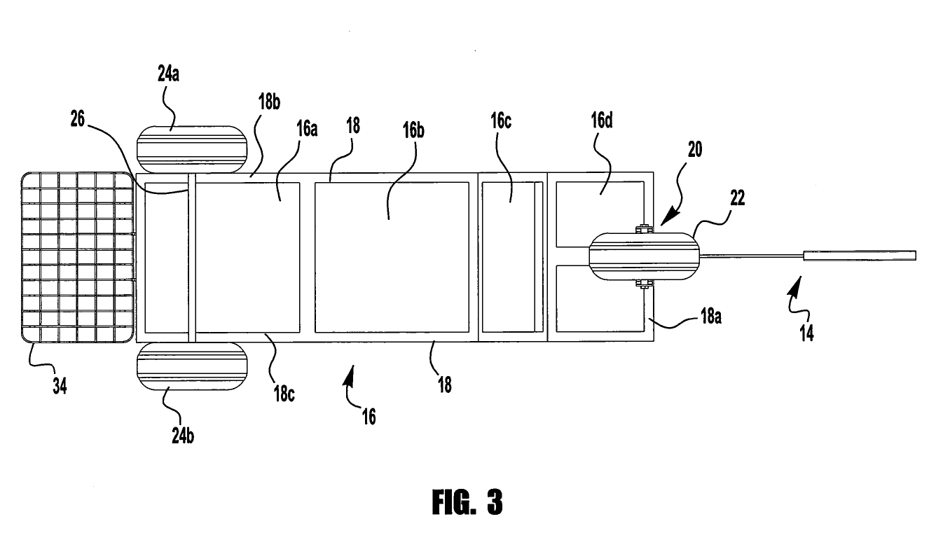

Trailer 10 consists of a platform base 16 that supports the various components of the trailer. As illustrated in FIG. 3, platform base 16 consists of four sections of steel plate, 16a, 16b, 16c, and 16d, framed and interconnected on all sides by tubing, such as square tubing 18. Steel plate sections 16a and 16b of the platform base 16 are parallel to each other and form the platform base 16. Steel plate section 16c is joined to section 16b at an angle of a range between 45° and 60° and preferably between 50° and 55°. Steel plate section 16d is joined to steel plate section 16c. Although this embodiment consists of the platform base 16 constructed of four steel plate sections 16a-16d being framed by square tubing 18, it is within the terms of the invention that the platform base be constructed of a solid unitary strip of material such as steel, or other appropriate material.

The tubular frame 18a in the front of the platform base 16 supports steel plate section 16d to which a front wheel assembly 20 is mounted. The front wheel assembly 20 consists of a front wheel 22 mounted in a wheel frame 23 which includes a swivel caster box 24 that is attached to a wheel support 25 to allow the front wheel 22 to pivot with respect to the platform base 16. These are, in turn, rigidly secured to the steel plate section 16d and the front tubular frame 18a. This design allows the front wheel 22 to be pivotable and allows for the steering of the trailer 10. Although the illustrated embodiment only contains a single front wheel 20, it is within the terms of the invention that there be two front wheels spaced from each other present. Two rear wheels 24a and 24b are attached to a rear axle 26, each being secured by any desired means such as a rotatable hub 26a, 26b (not shown). The rear axle 26 is secured to and below the steel plate section 16a of the platform base 16, such as by the tubing 18b and 18c.

The steel plate section 16a of the platform base 16 supports the rear box 28. Mounted upon rear box 28 is the seat 30. Seat 30 consists of a frame 30a, to which bottom cushion 30b and upper cushion 30c are secured. In the present embodiment, two side arms 32a and 32b extend from the upper cushion 30c. However, note also that it is possible that the frame 30a has two side arms that are pivotally attached and may be raised to allow the passenger easy access to the seat 30. When in use, the person may sit in seat 30 and rest his feet upon the top of steel plate section 16b. Further mounted upon the rear of rear box 28 is basket 34, to be used as a storage container for the trailer 10. Further, the rear box 28 forms an opening between the box and the platform base 16 to create a storage space 36.

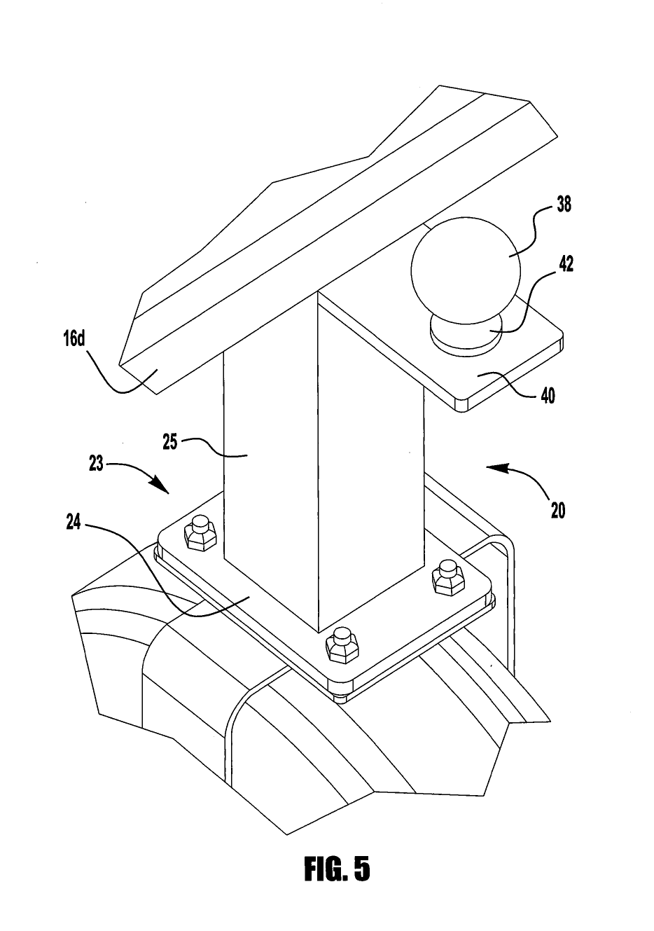

FIG. 5 shows a close-up view of the hitching ball 38, secured atop a platform 40 adjacent to wheel support 25. Hitching ball 38 is mounted upon a support base 42. The purpose of hitching ball 38 is to receive the coupler socket 44, as seen in FIG. 6. This mechanism allows the hitching assembly 12 to properly operate.

FIG. 6 illustrates the components of the hitching assembly 12. The design allows for ease in maneuvering the trailer 10 through a turn. A coupling socket 44 is mounted about the hitching ball 38. The coupling socket 44 is preferably easily removable from the hitching ball 38, and may be attached in any appropriate fashion, such as with pin 45. Coupling socket 44 is able to swivel about hitching ball 38 to accommodate for turns that mobility scooter 12 may make. Attached to the coupling socket 44 is an elongated connecting rod which includes a first connector bar 46, strip 48, and a second connector bar 50. Connected to the underside portion 46a of first connector bar 46 is connector strip 48, which is also attached to the topside portion 50a of a second connector bar 50. Second connector bar 50 is attached to the rear of the mobility scooter 12, through any appropriate measure, such as welding. This hitching assembly 12 allows the trailer 10 to be pulled pulled behind the mobility scooter 12, with a second passenger. Because of the swiveling nature of coupling socket 44 about hitching ball 38, trailer 10 may seamlessly follow mobility scooter 12.

According to an embodiment of the invention a method, a method of transporting a person on a trailer 10 adapted to be attached to a mobility scooter 12. The steps include supporting a platform base 16 on at least two wheels, 24a and 24b, securing at least one seat 30 on the platform base, and attaching the platform base to the mobility scooter 12 with a hitching assembly 14. The method further includes providing the hitching assembly 14 with a hitching ball 38 which is secured to the platform base 16. An elongated connecting rod, having a coupler socket 44 mounted at a first end, is mounted to the hitching ball 38 and connecting the elongated connecting rod at a second end to the mobility scooter 12. The coupler socket 44 may be connected to the hitching ball 38 utilizing a pin 45 to secure the coupling socket thereto.

The method of transporting a person utilizing a trailer 10 may further include providing at least one pivotable front wheel 22 to the platform base 16. The method may further include mounting the pivotable front wheel 22 in a wheel assembly 20 attached to the platform base 16. The method may include mounting the pivotable front wheel 22 to a swivel caster box 24 that is attached to a wheel support 25 attached to the platform base 16 so that the front wheel can pivot with respect to the platform base.

The method of transporting a person utilizing a trailer 10 may further include the platform base 16 including a rear box 28 with the seat 30 attached, and providing an opening to a storage space 36 between the box and the platform base 16. Further, the method may include securably mounting a basket 34 to the rear box 28.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A trailer for transporting a person adapted to be attached to a mobility scooter, comprising;
a platform base supported on at least two wheels;
at least one seat on the platform base; and
a hitching assembly to attach the platform base to the motorized scooter.

2. The trailer for transporting a person of claim 1, wherein the hitching assembly has a hitching ball which is secured to the platform base.

3. The trailer for transporting a person of claim 2, wherein the hitching assembly has a coupler socket adapted to be securably attached to the hitching ball.

4. The trailer for transporting a person of claim 3, wherein an elongated connecting rod is mounted at a first end to the coupler socket and is adapted to be connected at a second end to the mobility scooter.

5. The trailer for transporting a person of claim 4, wherein the coupler socket is connected to the hitching ball utilizing a pin to secure the coupling socket thereto.

6. The trailer for transporting a person of claim 1, wherein at least one pivotable front wheel is attached to the platform base.

7. The trailer for transporting a person of claim 6, wherein at least one pivotable front wheel mounted in a wheel assembly attached to the platform base.

8. The trailer for transporting a person of claim 7, wherein the pivotable front wheel is mounted to a swivel caster box that is attached to a wheel support attached to the platform base so that the front wheel can pivot with respect to the platform base.

9. The trailer for transporting a person of claim 1, wherein arms are incorporated as part of the construction of the seat.

10. The trailer for transporting a person of claim 1, wherein the platform base has a rear box having the seat attached thereon mounted onto the floor, the rear box formed with an opening to a storage space between the box and the platform base.

11. The trailer for transporting a person of claim 10, wherein a basket is securably mounted to the rear box.

12. A method of transporting a person on a trailer adapted to be attached to a mobility scooter, comprising;
supporting a platform base on at least two wheels;
securing at least one seat on the platform base; and
attaching the platform base to the mobility scooter with a hitching assembly.

13. The method of transporting a person utilizing a trailer of claim 12, including providing the hitching assembly with a hitching ball which is secured to the platform base.

14. The method of transporting a person utilizing a trailer of claim 13, including mounting an elongated connecting rod having a coupler socket mounted at a first end to the hitching ball and connecting the elongated connecting rod at a second end to the mobility scooter.

15. The method of transporting a person utilizing a trailer of claim 14, including connecting the coupler socket to the hitching ball utilizing a pin to secure the coupling socket thereto.

16. The method of transporting a person utilizing a trailer of claim 12, including providing at least one pivotable front wheel to the platform base.

17. The method of transporting a person utilizing a trailer of claim 16, including mounting the at least one pivotable front wheel in a wheel assembly attached to the platform base.

18. The method of transporting a person utilizing a trailer of claim 17, including mounting the pivotable front wheel to a swivel caster box that is attached to a wheel support attached to the platform base so that the front wheel can pivot with respect to the platform base.

19. The method of transporting a person utilizing a trailer of claim 12, including:
the platform base including a rear box with the seat attached thereon; and
providing an opening to a storage space between the box and the platform base.

20. The method of transporting a person utilizing a trailer of claim 19, including securably mounting a basket to the rear box.
